(19) United States
(12) Patent Application Publication
(10) Pub. No.: US 2023/0382102 A1
(43) Pub. Date: Nov. 30, 2023

(54) Laser and ink-jet friendly dark fabric transfer

(71) Applicant: Ready, Set, Co., LLC, Plymouth, MN (US)

(72) Inventors: Jodi Schwendimann, Wayzata, MN (US); Hemant Bohra, Minnetonka, MN (US)

(73) Assignee: Ready, Set, Co., LLC, Plymouth, MN (US)

(21) Appl. No.: 18/319,844

(22) Filed: May 18, 2023

Related U.S. Application Data
(60) Provisional application No. 63/345,290, filed on May 24, 2022.

(51) Int. Cl. B41J 2/005; G03G 15/16

(52) U.S. Cl. CPC B41J 2/0057; G03G 15/162

(57) ABSTRACT

Image transfer articles and method of using image transfer articles to apply and image to a receptor. The image transfer articles include a melt transfer layer, an image receiving layer configured to receive an indicia and/or image and including at least one wax treated silica pigment, and at least one opaque layer between the melt transfer layer and the image receiving layer. The melt transfer layer includes a bottom surface position-able against a receptor element during a transfer process. The at least one opaque layer is configured to provide an opaque background for at least a portion of the indicia and/or image.

### BACKGROUND

Textiles such as shirts (e.g., tee shirts) having a variety of designs thereon have become very popular in recent years. Many shirts are sold with pre-printed designs to suit the tastes of consumers. In addition, many customized tee shirt stores are now in the business of permitting customers to select designs or decals of their choice. Processes have also been proposed which permit customers to create their own designs on transfer sheets for application to tee shirts by use of a conventional hand iron, such as described in U.S. Pat. No. 4,244,358. Furthermore, U.S. Pat. No. 4,773,953, is directed to a method for utilizing a personal computer, a video camera or the like to create graphics, images, or creative designs on a fabric. These designs may then be transferred to the fabric by way of an inkjet printer, a laser printer, or the like.

Other types of heat transfer sheets are known in the art. For example, U.S. Pat. No. 5,798,179 is directed to a printable heat transfer material using a thermoplastic polymer such as a hard acrylic polymer or poly (vinyl acetate) as a barrier layer, and has a separate film-forming binder layer. U.S. Pat. No. 5,271,990 relates to an image-receptive heat transfer paper which includes an image-receptive melt-transfer film layer comprising a thermoplastic polymer overlaying the top surface of a base sheet. U.S. Pat. No. 5,502,902 relates to a printable material comprising a thermoplastic polymer and a film-forming binder. U.S. Pat. No. 5,614,345 relates to a paper for thermal image transfer to flat porous Surfaces, which contains an ethylene copolymer or an ethylene copolymer mixture and a dye-receiving layer. Other examples of heat transfer materials are disclosed by, for example, U.S. Pat. No. 6,410,200 which relates to a polymeric composition comprising an acrylic dispersion, an elastomeric emulsion, a plasticizer, and a water repellant. U.S. Pat. No. 6,358,660 relates to a barrier layer. The barrier layer of U.S. Pat. No. 6,358,660 provides for “cold peel,” “warm peel’ and “hot peel” applications and comprises thermosetting and/or ultraviolet (UV) curable polymers. U.S. application Ser. No. 09/980,589, filed Dec. 4, 2001, relates to a transferable material having a transfer blocking overcoat and to a process using said heat transferable material having a transfer blocking overcoat. Some of the above-mentioned applications contain specific systems for forming clear images which are subsequently transferred onto the receptor element. However, other heat transfer systems exist, for example, those disclosed by U.S. Pat. Nos. 4,021,591, 4,555,436, 4,657,557, 4,914,079, 4,927,709, 4,935,300, 5,322,833, 5,413,841, 5,679,461, 5,741,387, and 6,432,514. Problems with many known transfer sheets is the expense involved in coating numerous solutions onto a support material and the overall feel of the imaged product.

### SUMMARY OF THE INVENTION

In order to attract the interest of consumer groups that are already captivated by the tee shirt rage described above, the present invention provides, in one embodiment, an improved transfer sheet. In another embodiment, the present invention provides for a process for preparing the transfer sheet. In another embodiment, the present invention provides for a heat transfer of images to a receptor element. The present invention represents a revolution in the image transfer industry. It is very inexpensive, has a very soft feel to the touch, and can be washed in the washing machine with deter gent. No special washing or drying procedures are required in order to preserve the transferred image. Additionally, it includes the advantages of a “peel-away’ imaging material. With a peel-away material, the image that is placed on the imaging material is transferred directly to the receptor element without need of an inverted or reversed image.

The present invention relates to an image transfer material, comprising a support, a melt transfer layer, an opaque layer, and an image receiving layer. Optionally, multiple opaque layers may be coated between the melt transfer layer and the image receiving layer. The image receiving layer may contain a wax treated pigment such as a wax coated silica and a polyurethane binder. Wax treated pigment, when used in conjunction with the polyurethane binder, improves color retention with ink-jet printing while also reducing or eliminating wax build-up in the printer. For example, the use of conventional wax systems generally causes a wax buildup in laser printers causes the printers to jam. By using wax treated pigments in combination with a polyurethan binder, the present image receiving layer incorporates a wax component without creating a risk of wax build up and paper jamming in the printer.

The present invention further relates to a process for preparing the above image transfer material. According to the present invention, the optional barrier layer is coated on the support, the melt transfer layer is applied onto the optionally barrier-coated support, and opaque layer(s) along with the image receiving layer is coated onto the laminated melt transfer layer. Ways of applying the melt transfer layer include extrusion and lamination.

The present invention further relates to a heat transfer process using the present image transfer material. First, the top surface of the image receiving layer is imaged using digital printing methods such as aqueous ink-jet printing, eco-solvent inkjet printing, latex ink-jet printing, electrostatic/laser printing, and HP Indigo printing technique. Next, the imaged, image receiving layer, opaque layer(s) and melt transfer layer are peeled away from the Support. Alternatively, in some embodiments, the image receiving layer, opaque layer(s) and melt transfer layer may be peeled away from the Support prior to imaging the image receiving layer. Then the imaged peeled material is placed, preferably imaged side up, on top of a receptor element and further optionally imaged. Next, heat is applied (e.g., by way of a hand iron, a heat press or similar), to the top of the image. Where a hand iron or a heat press is used, a tack-free sheet should be placed between the iron or heat press and the imaged material. Upon heating, the melt transfer layer melts and adheres the opaque and image receiving layers to the receptor element. After heat application, the non-stick sheet is removed, and the image remains attached to the receptor element.

### BRIEF DESCRIPTION OF THE DRAWINGS

The present invention will become more fully understood from the detailed description given hereinbelow, and the accompanying drawings that are given by way of illustration only and thus are not limiting of the present invention, and wherein:

FIG. 1 is a cross-sectional view of one embodiment of the transfer element of the present invention;

FIG. 2 illustrates the step of ironing the transfer element of the present invention onto a tee shirt or the like.

### DETAILED DESCRIPTION OF THE INVENTION

The present application claims priority to provisional application No. 63/345,290, filed May 24, 2022 and entitled Laser and Ink-jet Friendly Dark Fabric Transfer, the disclosure of which is hereby incorporated by reference in the entirety.

The present invention relates to an image transfer material, comprising a support, a melt transfer layer, an opaque layer and an image receiving layer. The top surface of the image receiving layer is receptive to digital imaging methods, for instance, inkjet printers such as aqueous, eco-solvent and latex ink-jet printers, electrostatic/laser printers or copiers, liquid electro-ink printers such as HP Indigo, etc. The opaque layer refers to a white layer which is positioned between the melt transfer layer and image receiving layer. This layer provides the needed opacity by imparting white background on dark transfer substrates. For instance, an image transfer material comprising the melt transfer layer, opaque layer(s) and an image receiving layer is imaged, placed melt transfer layer down on a receptor element, and then adhered using a heat source.

The present invention further relates to a process for preparing the above image transfer material. According to the present invention, optionally at least one barrier layer is coated on the support, and the melt transfer layer is coated onto the optionally barrier-coated support. Possible ways of applying the melt transfer layer include extrusion and lamination. Next, the opaque layer(s) and image receiving layer is coated onto the melt transfer layer.

The present invention further relates to a heat transfer process using the same material. For instance, before or after imaging, the image receiving layer, opaque layer(s) and melt transfer layer are peeled away from the support material and placed, preferably image side up, on top of a receptor element. Such as cotton or cotton/polyester blend fabrics or the like. A non-stick sheet is then placed over the imaged peeled material and heat, for instance, from a source such as a hand iron or a heat press, is applied to the top of the non-stick sheet. The melt transfer layer then melts and adheres the image to the receptor element. After heat application, the non-stick sheet is removed, and the image remains attached to the receptor element.

In one embodiment, the present invention relates to an image transfer material, comprising a support, a melt transfer layer, an opaque layer and an image receiving layer. Optionally, more opaque layers may be coated between the melt transfer layer and the image receiving layer.

In another embodiment, the present invention relates to a process for preparing the above image transfer material. According to the present invention, the optional barrier layer is coated on the support, the melt transfer layer is extrusion coated or laminated onto the optionally barrier-coated support, opaque layer(s) and the image receiving layer is coated onto the laminated transfer layer. In yet another embodiment, the present invention further relates to a heat transfer process using the present image transfer material. First, the top surface of the image receiving layer is optionally imaged using any imaging technique including but not limited to, ink jet printers, bubblejet printers, thermal inkjet methods, piezo inkjet methods, laser printers, HP Indigo, markers, crayons, and the like. Next, the imaged, image receiving layer, opaque layer(s) and melt transfer layer are peeled away from the support (e.g., peeled in the absence of water or other chemical aid). Alternatively, the layers may be peeled away from the support prior to imaging the image receiving layer. Then the imaged and peeled material is placed, preferably imaged side up, on top of a receptor element and optionally imaged. Next, heat is applied (e.g., by way of a hand iron, a heat press or an oven), to the top of the image. If a hand iron or a heat press is used, a tack-free sheet should be placed between the iron or heat press and the imaged material. Upon heating, the melt transfer layer melts and adheres the opaque layer(s) and imaged image receiving layer to the receptor element. After heat application, the non-stick sheet is removed, and the image remains attached to the receptor element.

The present invention also provides for a kit containing the transfer sheet of the present invention and instructions for transferring an image thereon. The kit may also optionally contain a tack-free sheet, markers, paint, crayons, tee-shirts, prep-shirts or other design aids.

A. The Transfer Material

1. Support Layer

The support is a thin flexible, but non-elastic carrier sheet. The support is not particularly limited and may be any conventional support sheet which is suitably flexible. Typically, the support sheet is a paper web, plastic film, metal foil, wood pulp fiber paper, vegetable parchment paper, lithographic printing paper or similar material, imparting release of melt transfer layer upon peeling.

In one embodiment of the present invention an appropriate support material may include but is not limited to a cellulosic nonwoven web or film, such as a smooth surface, heavy weight (approximately 24 lb.) laser printer or color copier paper stock or laser printer transparency (polyester) film. However, highly porous supports are less preferred because they tend to absorb large amounts of any material coated thereon. The particular support used is not known to be critical, so long as the support has sufficient strength for handling, copying, coating, heat transfer, and other operations associated with the present invention. Accordingly, in accordance with some embodiments of the present invention, the support may be the base material for any printable material. Such as described in U.S. Pat. No. and RE41,623E. In a preferred embodiment, the support layer is 50-200 GSM paper. Alternatively, release coated substrates could be utilized for the support layer. Substrates containing release coated surface; coated with fluorocarbon, urethane, acrylic base polymer or silicone release coating could be utilized as support layer of the present invention. The silicone coating has a release value of about 10 to 2500 g/inch, using a Tesa Tape 7375 tmi, 90 degree angle, 1 inch tape, 12 inches per minute.

2. Optional Barrier Layer

The support may contain an optional barrier coating on one or both support surfaces. Any suitable barrier layer enhancing release of melt transfer layer may be used. For instance, barrier layers may include, but are not limited to, the barrier layers disclosed in U.S. Pat. Nos. 6,410,200, 6,358,660, 5,271,990, and 5,242,739, which are herein incorporated by reference. Other suitable barrier layers include those disclosed in U.S. Pat. Nos. 4,021,591, 4,555,436, 4,657,557, 4,914,079, 4,927, 709, 4,935,300, 5,322,833, 5,413,841, 5,679,461, 5,741,387, 5,798,179, and 5,603,966, all of which are herein incorporated by reference.

Lastly, suitable barrier layers include the barrier layers of U.S. Pat. Nos. 4,773,953, 4,980,224, 5,139,917, 5,236,801, 5,883,790, 6,245,710, 6,083,656, 5,948,586, 6,265,128, 6,033,824, 6,294,307, 6,410,200 and 6,358,660, and U.S. application Ser. Nos. 09/366,300, 09/547,760, 09/637,082, 09/828,134, 09/980,589, 09/453,881, 09/791,755, 10/089,446, and 10/205,628, and Provisional U.S. Application Ser. Nos. 60/396,632 and 60/304,752.

Coat weights for the barrier layer may range from one 1 g/m² to 20 g/m², preferably from 1 g/m² to 15 g/m², most preferably 1 g/m² to 8 g/m². The barrier layer herein may comprise silicon or silicone containing compound.

3. The Melt Transfer Layer

The melt transfer layer is applied on top of the support. Any melt transfer layer may be used, for instance, any of the melt transfer layers disclosed in U.S. Pat. Nos. RE41,623E. 6,410,200, 6,358,660, 5,271,990, 5,242, 739, 4,021,591, 4,555,436, 4,657,557, 4,914,079, 4,927,709, 4,935,300, 5,413,841, 5,679,461, 5,741,387, 5,798,179, 5,603,966, 4,773,953, 4,980,224, 5,620,548, 5,236,801, 5,883,790, 6,245,710, 6,083,656, 5,948,586, 6,265,128, 6,033,824, 6,294,307, 6,410,200 and 6,358,660, and U.S. application Ser. Nos. 09/366,300, 09/547,760, 09/637,082, 09/828,134, 09/980,589, 09/453,881, 09/791,755, 10/089,446, and 10/205,628, and Provisional U.S. Application Ser. Nos. 60/396,632 and 60/304,752, all of which are herein incorporated by reference.

Preferably, the melt transfer layer has a slight tack which keeps the image receiving layer attached on the support during imaging and handling. That is, the melt transfer layer preferably has sufficient tack to hold it onto the support layer. However, the tack must not be so strong as to permanently bond the melt transfer layer to the support. The preferred tack would be similar to that found with an adhesive class of polymer coatings known as the removable pressure sensitive adhesives (e.g., 3M “Post-It’). A removable pressure sensitive adhesive is characterized as an adhesive that allows two surfaces to be separated, reversibly, without damage to either surface.

After printing/copying/drawing, the image receiving layer is peeled away from the support material. During the peeling process, the melt transfer layer comes away with the opaque and image receiving layer and will serve as the source of adhesion during the transfer upon the application of heat.

The melt transfer layer is coated onto the top of the support or optional barrier layer. The thickness ranges from 1 to 5 mils, preferably 1 to 2 mils, most preferably about 1.5 mils. The melt transfer layer has a dry coat of about 2 to 40 g/m², a preferred dry coat weight would be 10-30 g/m².

The melt transfer layer could be a polyurethane layer having sufficient thickness that upon melting adheres to the receptor element. Preferred thickness for the polyurethane layer range from about 1.0 mils to 2.0 mils.

Any polyester, acrylic polymer, polyolefin, polyurethane, ethylene acrylic acid, ethylene vinyl acetate or copolymer blends may be used for melt transfer layer that exhibits a melt transition temperature in the range 40° C.-250° C., or when the glass transition temperature (Tg) of the polyolefin, polyester, polyurethane, acrylic polymer or copolymer blend is less than about 25 degrees Centigrade. Preferably, the Tg will fall between about 25° C. and 120° C. and display a slight tack when touched. Non-limiting examples include polyamide (4220; Bemis Associates), polyurethane (5250; Bemis Associates; Estane™ 5700 series, in particular Estane™ 5703 TPU of Noveon, Inc. Cleveland Ohio; or Daotan polyure thanes by Surface Specialties, Inc. UBC), polyester (UAF 425 or PAF-1 10; Adhesive Films, Inc.), and polyester (Integral Film 801: Dow Co.)

In one embodiment, the melt transfer layer comprises an ethylene vinyl acetate/ethylene acrylic acid copolymer blend. In another embodiment, the melt transfer layer comprises a EVA based terpolymer of ethylene-vinyl acetate and maleic anhydride terpolymer. In another embodiment, the melt transfer layer comprises polyurethane. Aspects of the polyurethane that are important include the softening temperature, softness of the polymer, color of the polymer and elasticity of the polymer. It is desirable to use a polyurethane that is as soft as possible but has high elastic properties. Polyurethane products having a Shore Hardness between 70 A and 90 A are preferred. Non-yellowing of the melt transfer layer is important and therefore the polyurethane should be non-yellowing. Aliphatic polyurethanes are more UV stable than other polyurethanes Such as aromatic polyurethanes and therefore can possess better non-yellowing properties.

In a preferred embodiment of the invention, the melt transfer layer comprises an ethylene acrylic acid co-polymer dispersion. The melt transfer layer could also be obtained upon extrusion coating ethylene acrylic acid or ethylene vinyl acetate copolymers. The melt transfer layer may also contain an acrylic dispersion, an elastomeric emulsion, a water repellant and a plasticizer.

The acrylic dispersion is present in a sufficient amount so as to provide adhesion of the melt transfer layer and image to the receptor element upon application of heat. The elastomeric emulsion provides the elastomeric properties such as mechanical stability, flexibility and stretchability. The water repellent provides water resistance and repellency, which enhances the wear resistance and washability of the image on the receptor. The plasticizer provides plasticity and antistatic properties to the transferred image. The acrylic dispersion may be an ethylene acrylic acid co-polymer dispersion that is a film-forming binder that provides the “release’ or “separation’ from the support. The melt transfer layer of the invention may utilize the film-forming binders of the image-receptive melt-transfer film layer of U.S. Pat. No. 5,242,739, which is herein incorporated by reference.

Thus, the nature of the film-forming binder is not known to be critical. That is, any film-forming binder can be employed so long as it meets the criteria specified herein. As a practical matter, water-dispersible ethylene-acrylic acid copolymers have been found to be especially effective film forming binders.

The term “melts’ and variations thereof are used herein only in a qualitative sense and are not meant to refer to any particular test procedure. Reference herein to a melting temperature or range is meant only to indicate an approximate temperature or range at which a polymer or binder melts and flows under the conditions of a melt-transfer process to result in a substantially smooth film.

Manufacturers' published data regarding the melt behavior of polymers or binders correlate with the melting requirements described herein. It should be noted, however, that either a true melting point or a softening point may be given, depending on the nature of the material. For example, materials such as polyolefins and waxes, being composed mainly of linear polymeric molecules, generally melt over a relatively narrow temperature range since they are somewhat crystalline below the melting point.

Melting points, if not provided by the manufacturer, are readily determined by known methods such as differential scanning calorimetry. Many polymers, and especially copolymers, are amorphous because of branching in the polymer chains or the side-chain constituents. These materials begin to soften and flow more gradually as the temperature is increased. It is believed that the ring and ball softening point of such materials, as determined by ASTM E-28, is useful in predicting their behavior. Moreover, the melting points or softening points described are better indicators of performance than the chemical nature of the polymer or binder.

In another embodiment of the invention, the polymer may be applied to optionally barrier-coated support in powder form, and then, heat is applied to form a coherent mass of the polymer on the support. This process is often referred to in the textile industry as powder sintering. Any polyethylene, polyamide or blends thereof may be used in the process. Vestamelt 350, 432,730,732 and 750 (Degussa Corp.) are examples of a polyolefin polyamide blends with a typical melt transition temperature in the range of 105-130° C. Polyethylene powders are typically low-density polyethylene (LDPE) compositions with a melt temperature in the range 50-250° C. preferably 70-190° C. and most preferably 80-150° C. LDPE examples include Microthene F501 (Equistar Chemical Co.) with a melt temperature of 104° C., and Icotex 520-5016 (Icopolymers Co.) with a melt temperature of 100° C.

Another component of Melt Transfer Layer could be an elastomeric emulsion, preferably a latex, and is compatible with the other components, and formulated to provide durability, mechanical stability, and a degree of soft ness and conformability to the layers.

Films of this material must have moisture resistance, low tack, durability, flexibility and softness, but with relative toughness and tensile strength. Further, the material should preferably have inherent heat and light stability. The latex can be heat sensitized, and the elastomer can be self-crosslinking or used with compatible cross-linking agents, or both. The latex should be sprayable, or roll stable for continuous runnability on nip rollers.

Elastomeric latexes of the preferred type are produced from the materials and processes set forth in U.S. Pat. Nos. 4,956,434 and 5,143,971, which are herein incorporated by reference. This curable latex is derived from a major amount of acrylate monomers such as C to Cs alkyl acrylate, preferably n-butyl acrylate, up to about 20 parts per hundred of total monomers of a monolefinically unsaturated dicarboxylic acid, most preferably itaconic acid, a small amount of crosslinking agent, preferably N-methyl acrylamide, and optionally another monolefinic monomer.

Using a modified semi batch process in which preferably the itaconic acid is fully charged initially to the reactor with the remaining monomers added over time, a latex of unique polymer architecture or morphology is created, leading to the unique rubbery properties of the cured films produced there from.

One of the ingredient of Melt Transfer Layer could be a water resistant and adhesion aid such as a polyurethane dispersion. Preferably, the polyurethane will be a self-crosslinking formulation incorporating crosslinking agents Such as melamine. This ingredient is also a softener for the acrylic dispersion and plasticizer aid.

Such polyurethane product may be produced by polymerizing one or more acrylate and other ethylenic monomers in the presence of an oligourethane to prepare oligourethane acrylate copolymers. The oligourethane is preferably prepared from diols and diisocyanates, the aliphatic or alicyclic based diisocyanates being preferred, with lesser amounts, if any, of aromatic diisocyanates, to avoid components which contribute to yellowing. Polymerizable monomers, in addition to the usual acrylate and methacrylate esters of aliphatic monoalcohols and styrene, further include monomers with carboxyl groups, such as acrylic acid or methacrylic acid, and those with other hydrophylic groups such as the hydroxyalkyl acrylates (hydroxyethyl methacrylate being exemplary). The hydrophylic groups in these monomers render the copolymer product dispersible in water with the aid of a neutralizing agent for the carboxyl groups, such as dimethylethanolamine, used in amount to at least partially neutralize the carboxyl groups after dispersion in water and vacuum distillation to remove any solvents used to prepare the urethane acrylic hybrid. Further formulations may include the addition of crosslinking components such as amino resins, strained amines or blocked polyisocyanates. Although pigments and fillers could be added to any of the coating layers. Such use to uniformly tint or color the web could be used for special effect, but would not be used where an image is desired in the absence of background coloration. Urethane acrylic hybrid polymers are further described in U.S. Pat. No. 5,708,072, and their description in this application is incorporated by reference.

Self crosslinking acrylic polyurethane hybrid compositions can also be prepared by the processes and materials of U.S. Pat. No. 5,691,425, herein incorporated by reference. These are prepared by producing polyurethane macromonomers containing acid groups and lateral vinyl groups, optionally terminal vinyl groups, and hydroxyl, urethane, thioureathane and/or urea groups. Polymerization of these macromonomers produces acrylic polyurethane hybrids which can be dispersed in water and combined with crosslinking agents for solvent-free coating compositions.

Auto-crosslinkable polyurethane-vinyl polymers are discussed in detail in U.S. Pat. Nos. 5,623,016 and 5,571,861, and their disclosure of these materials is incorporated by reference. The products usually are polyurethane acrylic hybrids, but with self-crosslinking functions. These may be carboxylic acid containing, neutralized with, e.g. tertiary amines such as ethanolamine, and form useful adhesions and coatings from aqueous dispersion.

The elastomeric emulsion and polyurethane dispersion are, generally, thermoplastic elastomers. Thermoplastic elastomeric polymers are polymer blends and alloys which have both the properties of thermoplastic polymers, such as having melt flow and flow characteristics, and elastomers, which are typically polymers which cannot melt and flow due to covalent chemical crosslinking (Vulcanization) or regions (blocks) of highly ordered polymeric units. Thermoplastic elastomers are generally synthesized using two or more monomers that are incompatible; for example, styrene and butadiene. By building long runs of polybutadiene with intermittent polystyrene runs, microdomains are established which imparts the elastomeric quality to the polymer system. However, since the microdomains are established through physical crosslinking mechanisms, they can be broken by application of added energy, such as heat from a hand iron, and caused to melt and flow; and therefore, are elastomers with thermoplastic quality.

Thermoplastic elastomers have been incorporated into the present invention in order to provide the image system with elastomeric quality. Two thermoplastic elastomer Systems have been introduced; that is, a polyacrylate terpolymer elastomer (for example, Hystretch V-29) and an aliphatic urethane acryl hybrid (for example, Daotan VTW 1265). Thermoplastic elastomers can be chosen from a group that includes, for example, ether-ester, olefinic, polyether, polyester and styrenic thermoplastic polymer systems. Specific examples include, by way of illustration, thermoplastic elastomers such as polybutadiene, polybutadiene derivatives, polyurethane, polyurethane derivatives, styrene-butadiene, styrene-butadiene-styrene, acrylonitrile-butadiene, acrylonitrile-butadiene-styrene, acrylonitrile-ethylene-styrene, polyacrylates, polychloroprene, ethylene-vinyl acetate and poly(vinyl chloride). Generally, thermoplastic elastomers can be selected from a group having a glass transition temperature (Tg) ranging from about −50° C. to about 25° C.

Although polyurethane is one component of one of the embodiments of the present melt transfer layer, the melt transfer layer may comprises polyurethane as the main or single component. The melt transfer layer as a polyurethane layer preferably has sufficient thickness that upon melting adheres to the receptor element. Preferred thickness for the polyurethane layer range from about 1.0 mils to 2.0 mils.

One of the component of Melt Transfer Layer could be a plasticizer such as a polyethylene glycol dispersion which provides mechanical stability, water repellency, and allows for a uniform, crack-free film. Accordingly, a reason to add the polyethylene glycol dispersion is an aid in the coating process. Further, the polyethylene glycol dispersion acts as a softening agent. A preferred fourth component is Carbowax Polyethylene Glycol 400, available from Union Carbide. An optional fifth ingredient of Melt Transfer Layer is a Surfactant and wetting agent such as polyethylene glycol mono ((tetramethylbutyl) phenol) ether. Alternatively, the representative binders, described above that are suitable for Melt Transfer Layer, may be used in lieu of the above-described ethylene acrylic acid copolymer dispersion.

The melt transfer layer could be composed of a crosslinking polymer, for example, polyurethane or polyethylene. When heat is applied to the melt transfer layer, it bonds to the receptor element. The bond created is durable to washing, dry-cleaning, and is durable under mechanical stress.

4. Opaque Layer(s) The present material may optionally contain more than one opaque layers, for instance the opaque layers described in U.S. patent Nos. RE41,623E, 7,785,764, 8,613,988, 9,227,461 and 9,371,148. In the present invention, the optionally more than one opaque layer(s) are placed between the melt transfer layer and the image receiving layer.

When one or more opaque layers are employed, the opaque layer provides additional background contrast for the applied image to render it visible against, for instance a dark or a light receptor. The opaque layer(s) improves the appearance and readability of an image. Such as, for instance, a bar code or a color image.

The thickness of the one or more opaque layer(s), should be sufficient to provide necessary thickness and rigidity for the intended use or mode of imaging of the transfer paper. Depending upon the intended use, the thickness and rigidity will vary. For example, if intended to be imaged with a printer, e.g., an inkjet printer, the combination of the melt transfer layer, one or more opaque layer and image receiving layer preferably have sufficient rigidity to as to pass through the printer without substantial damage. Exemplary total thickness of opaque layer(s) in such an instance range from about 2 mils to about 7 mils.

When permanently adhering the image material to a textile, the opaque layer(s) layers preferably will be thermoplastic or thermosetting as they are applied to a porous substrate such as a fabric. When a thermosettable formulation is employed for the opaque layers, the image fused into the fabric will have the maximum resistance to washing or dry cleaning.

The opaque layer(s) add a rigid or stiff quality to the entire heat-setting label sheet for ease of handling such as peeling; while yielding a white background. Any pigmented resin or binder with a pigment loading may be used to achieve the desired outcome.

The Opaque Layer preferably contains a pigment (such as a white pigment) and provides opacity. A preferred embodiment of the opaque layer, Opaque Layer Formulation 1, comprises of polyurethane binders, pigment dispersants, white pigment such as TiO₂, polyethylene glycol (plasticizer), surfactants, wax emulsion and rheology modifier.

The thermoplastic elastomer acrylonitrile copolymer, if used in the opaque layer, imparts stretchability and flexibility in the final transferred product. Practically any TiO₂, powder addition, present at about 25% to 60% of the total formula, will provide the desired opacity. Other powdered pigments may need to be added at varying percentages to achieve the desired opacity and color intensity.

An embodiment of opaque layer comprises styrene-butadiene latex, thermosplastic elastomer, an elastomer and a pigment.

All the above chemicals form a homogeneous dispersion aided by a stir bar at a low to medium stirrate. All mixing can be done at room temperature. After coating, the preferred total thickness of Opaque Layer(s) are about 2 mils to 7 mils (dry).

In the above-described embodiment, a pigment such as a white pigment may be used to exhibit opacity capabilities. Also, in an embodiment, the latex is the primary chemical imparting the rigid characteristics upon drying. The thermoplastic elastomer and acrylonic copolymer impart stretchability and flexibility in the final transferred product.

All liquid chemicals are homogenized in the presence of a stir bar and a low speed. Upon homogenization, the pigment powder is added slowly in the presence of a high stir speed provide by a stir flea. All mixing of the above ingredients should be performed at room temperature. Preferably, optional Opaque Layer 1 is coated on the heat setting label sheet at a dry weight of about 30 g/m² to 60 g/m².

5. The Image Receiving Layer

An image receiving layer is applied over the melt transfer layer. The image receiving layer formulations of the present invention should be able to retain an image such as an image dye. The image receiving layer retains dyes, such as ink from inkjet printers, or dyes from a water-based marker. If an inkjet ink is utilized, the image preferably has comparable resolution to standard inkjet paper. In one embodiment, the image receiving layer may become heat activated (e.g. melt and flow) to trap or encapsulate the dye image or ink and option ally impart water-fast characteristics.

The image receiving layer may be applied to the melt transfer layer either by a conventional saturating process Such as a “dip and squeeze’ process or with a coating process such as a reverse roll, meyer rod, gravure, slot die and the like.

The basis weight of the image receiving layer may vary from about 2 to about 30 g/m². Desirably, the basis weight will be from about 3 to about 20 g/m².

The image receiving layer is capable of heat sealing the image upon application of heat up to 220° C. “Heat sealing as defined herein refers to a process whereby the polymer composition melts and flows so as to effectively encapsulate the image forming colorants therein. Heat sealing imparts water-fastness and washability. A heat-sealed image would have newly imparted image permanence properties such as water-fastness and rub resistance. In one embodiment, the image receiving formulation includes a self-crosslinking polymer as a binder. In this embodiment, although not all components of the image receiving layer will technically melt, for instance, the self-crosslinking EVA polymer will not melt, the layer will still heat seal the image.

The image receiving layer comprises binders, such as polyvinyl alcohol (PVOH), polyesters, polyurethanes, or co-polymer blends, vinyl acetate-ethylene, various colorant retention aids, various optional crosslinking agents, an optional antioxidant, or an optional softening agent.

The binder imparts colorant retention and mechanical stability. A list of applicable binders include, but are not limited to, those listed in U.S. Pat. No. 5,798,179, in addition to polyolefins, polyesters, ethylene-vinyl acetate copolymers, ethylene-methacrylate acid copolymers, and ethylene-acrylic acid copolymers. The binder may also be selected from the list, mentioned herein, for use in the melt transfer layer.

The binder could be one of a self-crosslinkable acrylic copolymer, for instance, Rhoplex™ NW-1402, Rhoplex™ HA-16 or RhopleX™ HA-12 from the Rohm and Haas Corporation, or a hydrolyzed polyvinyl alcohol, for instance, Celvol™ 540 or Celvol™ 125, from the Celanese Corporation, or a self-crosslinking ethylene-vinyl acetate copolymer, for instance, Dur-o-set™ Elite Plus 25-299A, from Vinamul Polymers Corp.

The self-crosslinkable polymer binder is preferably present in an amount, based on the dry solids content of the layer, of 15-40%, and most preferably 25-35% by weight. The self-crosslinkable polymer binder is a thermosetting polymer such as a self-crosslinking ethylene vinyl acetate copolymer (for instance. Dur-o-set Elite Plus 25-299A, from Vinamul Polymers Corp.).

Thermoplastic binders, other than the self-crosslinkable polymers discussed above, may also be incorporated. For instance, any of the thermoplastic binders listed above for the melt transfer layer may be incorporated. For instance, thermoplastic binders, such as those listed above may be incorporated in amounts of 5-40%, preferably 10-30% by weight based on the dry solids content.

Additionally, a polyamide copolymer, for instance, a nylon copolymer may be added to the image receiving layer. For instance, nylon 6-12 (Orgasol 3501 EXDNAT 1, from Arkema), nylon 12 (Orgasol 2002 EXDNAT 1, from Arkema), and nylon 6 (Orgasol 1002 DNAT1, from Arkema). The formulation may also include a polyvinylpyrrolidone (PVP) polymer and copolymer blends for instance, Luvicross (BASF), Luvicross M (BASF), Luvicross VI (a PVP-vinyl imidazole copolymer blend (BASF)), and Luvitec (BASF).

Although wax can provide useful qualities to the image receiving layer, wax can also cause problems. For example, the use of wax can lead to a wax buildup within laser printers, resulting in jamming of laser printer mechanisms. Because of this, the use of wax was previously either avoided or kept to very low levels in materials used with printer. As described further below, various embodiment described herein include a new method of incorporating wax into the image receiving layer that overcomes the problem of wax buildup in printer mechanisms and printer jamming.

In various embodiments, the image receiving layer includes a wax treated pigment such as a wax coated silica. The wax treated pigment may have a particle size of between about 4 and about 10 micrometers, such as about between about 5 and about 7 micrometers. Examples of wax coated silica which may be used in various embodiments include OK 412, OK 607 available from Evonik (Essen, Germany) or similar wax treated silica.

The wax treated pigment may be included in the image receiving layer in combination with a binder such as a polyurethane binder. The polyurethane binder may include a cationic polyurethane and/or a non-ionic polyurethane, for example. The polyurethane binder may be the only binder or may be used in combination with a co-binder such as a vinyl acetate-ethylene emulsion.

The image receiving layer including a wax treated silica pigment and a polyurethane binder system yields good print attributes with ink-jet printing without wax build-up in laser printers. As such, the same image receiving layer may be used with both ink jet printers and laser printers, providing improved print quality for ink-jet printers without impacting the laser printer performance. The inclusion of one or more wax-treated pigments in the image receiving layer provides additional advantages. For example, wax-treated pigments help reduce the settling of pigments which can be a problem with liquid coatings. In various embodiments, the same image receiving layer is capable of being imaged by any of the various digital imaging techniques such as electrostatic/laser printers, inkjet printing such as aqueous, eco-solvent and latex printers, and liquid toner printing methods such as HP Indigo. As such, the image receiving layer is highly versatile and may be used by a wide range of customers having many different types of printer systems.

The wax treated silica may be used alone or in combination with other wax components such as wax-based water repellants. In such embodiments, a higher amount of wax may be used in the image receiving layer than was previously possible, without causing wax buildup in the printer. For example, the amount of wax treated silica, alone or in combination with other wax such as the wax-based water repellant, may be greater than 30% by weight of the image receiving layer on a dry weight basis. For example, the amount of wax treated silica and wax components may be about 30% to about 40% of the image receiving layer on a dry weight basis.

In some embodiments, the image receiving layer includes wax-coated silica, a polyurethane binder, a polyamide which may aid color retention, a water repellant which may provide durability during wash cycles, and surface additives such as surfactants which may provide good surface wetting.

Silica may also be added to the image receiving layer in conjunction with the above wax-treated pigment. Silica is silicon dioxide, and can generally be any preparation that has a mean diameter not larger than 100 microns. Examples include the Syloid brand of silica (such as Syloid W-500, from Grace Davidson Co.), Sylojet brand of silica (such as the Sylojet P400, Grace Davidson Co.), INEOS silica (such as the Gasil HP270 or Gasil IJ45).

An antioxidant may be added to keep the binder from discoloring (yellowing) during the heat process. Suitable antioxidants include, but are not limited to. BHA; Bis(2,4-dit-butylphenyl)pentaerythritol diphosphite; 4,4′-Butylidenebis(6-t-butyl-m-cresol), C20-40 alcohols; p-Crescol/dicyclopentadiene butylated reaction product, Di(butyl, methylpyrophosphato)ethylene titanate di(dioctyl, hydrogen phosphite); Dicyclo(dioctyl)pyrophosphato titanate; DiCdioctylphosphato)ethylene titanate; Di(dioctylpyrophosphato) ethylene titanate; Disobutylnonyl phenol; Dimethylaminom ethyl phenol, Ethylhydroxymethyloleyl oxazoline Isopropyl 4-aminobenzenesulfonyl di(dodecylbenzenesulfonyl)titanate; Isopropyldimethacrylisoslearoyltitanate; Isopropyl (dioctylphosphato)titanate; isopropyltridioctylpyrophosphato) titanate; Isopropyl tri(N ethylamino-ethylamino)titanate, Lead phthalate, basic 2.2-Methylenebis (6-t-butyl-4-methylphenol), Octadecyl 3,5-di-t-butyl-4-hydroxyhydrocin namate Phosphorus; Phosphorus trichloride, reaction prods. with 1,1′-biphenyl and 2.4-bis(1,1-dimethylethyl)phenol Tetra (2, diallyoxymethyl-1 butoxy titanium di(di-tridecyl) phosphite; Tetraisopropyl di(dioctylphosphito)titanate; Tet rakis methylene (3,5-di-t-butyl-4-hydroxyhydrocin namate)methane; Tetraoctyloxytitanium; di(ditridecylphosphite); 4,4′-Thiobis-6-(t-butyl-m-cresol): Titanium di(butyl, octyl pyrophosphate)di(dioclyl, hydrogen phosphite)oxyacetate; Titanium di(cumylphenylate)oxyac etate; Titaniumdi (dioctylpyrophosphate), oxyacelate; Tita nium dimethyacrylate oxyacetate; 2.2,4-Trimethyl-1,2-dihydro-quinoline polymer, Tris(nonylphenyl)phosphite. Preferably, the antioxidant used is octadecyl 3,5-Ditert-butyl 4-hydroxyhydrocinnamate.

An optional crosslinking agent can be added to each formula to crosslink the binder to improve water fastness. Crosslinkers Suited for this application including, but not limited to, aziridine (ie., Ionac PFAZ-322), aziridine derivatives, multifunctional aziridines (XAMA-7 (Sybron)) Sancure 777 (Noveon), and melamine (ie., Cymul 323 EvCo. Inc.), and organometallics like an organic titanate such as Tyzor LA (DuPont).

The self-crosslinkable polymer binder-containing image receiving formulation may further include dye retention aids, such as a cationic polymer. Other dye retention aids include the silica listed above, the polyamide copolymer and PVA. The cationic polymer may be incorporated in amounts of 1-10% by weight, preferably 1-4% by weight based upon the dry solids content of the layer. Other dye retention aids may include any salt with dissociative properties. Exemplary, but non-limiting examples include salts with Group II elements Such as Mg, CA, Sr or Ba, or other elements such as Al, Zn, and Cu. Preferably CaCl may be utilized as a dye retention aid. The salt with dissociative properties may be present in amounts of 0.25-4%, preferably 1-2% by weight based upon the dry weight of the formulation. The cationic polymer may be, for example, an amide-epichlorohydrin polymer, poly acrylamides with cationic functional groups, polyethyleneimines, polydiallylamines, and the like.

When a cationic polymer is present, a compatible binder should be selected. Such as a nonionic or cationic dispersion or solution. As is well known in the paper coating art, many commercially available binders have anionically charged particles or polymer molecules. These binders are generally not compatible with the cationic polymer which may be used in the image receiving layer.

The image receiving layer may contain the addition of filler agents with the purpose of modulating the surface characteristics of the present invention. The surface roughness and coefficient of friction may need to be modulated depending on such factors as desired surface gloss and the imaging device's specific paper feeding requirements.

The filler can be selected from a group of polymers such as, for example, polyacrylates, polyacrylics, polyethylene, polyethylene acrylic copolymers and polyethylene acrylate copolymers, vinyl acetate copolymers and polyvinyl polymer blends that have various particle dimensions and shapes. Typical particle sizes may range from 0.1 to 500 microns. Preferably, the particle sizes range from 5 to 100 microns. More preferably, the particle sizes range from 5 to 30 microns. The filler may also be selected from a group of polymers such as, for example, cellulose, hydroxycellulose, starch and dextran. Silicas and mica may also be selected as a filler. The filler is homogeneously dispersed in the image receiving layer in concentrations ranging from 0.1 to 50%. Preferably, the filler concentration range is 1 to 10 percent.

The image receiving layer may also contain rheology modifiers and defoaming or anti-foaming agents. An example of a rheology modifier is a Laponite product by Southern Clay Products, Inc., Gonzales, Tex.; or AlcogumR L-520 (Alco Chemical).

6. Optional Antistatic Layer

An antistatic layer may be coated on the back of the support opposite the melt transfer layer. Any suitable antistatic layer known in the art may be used as the antistatic layer of the present invention. In accordance with one embodiment of the invention, the support is usable in a laser copier or laser printer. A preferred support for this embodiment is equal to or less than approximately 4.0 mils thick. The antistatic layer according to the present invention may have a solution viscosity of from 0.1 to 20 cps, preferably 1-5 cps, most preferably about 2 cps, as measured on a Brookfield DV-II+viscometer, LV1 spindle at 60 rpm at a temperature of 25° C. Additionally, the antistatic layer may be wet coated in an amount of from 1 g/m² to 50 g/m², preferably from 10-30 g/m², most preferably about 18 g/m².

Since the support is useable in a laser copier or laser printer, antistatic agents may be present. The antistatic agents may be present in the form of a coating on the back surface of the support as an additional layer. The back Surface of the support is the surface that is not previously coated with the melt transfer layer.

When the antistatic agent is applied as a coating onto the back surface of the support, the coating will help eliminate copier or printer jamming by preventing the electrostatic adhesion of the paper base to the copier drum of laser and electrostatic copiers and printers. Antistatic agents, or “anti-stats are generally, but not necessarily, conductive polymers that promote the flow of charge away from the paper. Anti-stats can also be “humectants’ that modulate the level of moisture in a paper coating that affects the buildup of charge. Anti-stats are commonly charged tallow ammonium compounds and complexes, but also can be complexed organometallics. Anti-stats may also be charged polymers that have a similar charge polarity as the copier/printer drum; whereby the like charge repulsion helps prevent jamming.

Antistatic agents include, by way of illustration, derivatives of propylene glycol, ethylene oxide propylene oxide block copolymers, organometallic complexes such as titanium dimethylacrylate oxyacetate, polyoxyethylene oxide polyoxypropylene oxide copolymers and derivatives of cholic acid.

More specifically, commonly used antistats include those listed in the Handbook of Paint and Coating Raw Materials, such as t-Butylaminoethyl methacrylate; Capryl hydroxy ethyl imidazoline; Cetethyl morpholinium ethosulfate: Cocoylhydroxyethylimidazoline Di(butyl, methylpyrophosphato) ethylenetitanate di(dioctyl, hydrogen phosphite); Dicyclo(dioctyl)pyrophosphato; titanate; Di(dioctylphosphato)ethylene titanate; Dimethyl diallyl ammonium chloride; Distearyldimonium chloride; N,N′-Ethylene bis-ricinoleamide: Glyceryl mono/dioleate: Glyceryl oleate; Glyceryl stearate; Heptadecenyl hydroxyethyl imidazoline: Hexylphosphate: N(beta.-Hydroxyethyl)ricinoleamide: N-(2-Hy droxypropyl)benzene sulfonamide; Isopropyl-4-aminoben Zenesulfonyl di(dodecylbenzenesulfonyl)titanate; Isopropyl dimethacryl isostearoyl titanate; isopropyltri (dioctylphosphato) titanate; Isopropyl tri(dioctylpyrophosphato) titanate; Isopropyl tri(Nethylaminoethylamino)titanate; (3-Laurami-dopropyl)trimethylammonium methylsulfate; Nonyl nonox ynol-15; Oleyl hydroxyethylimidazoline; Palmitic/stearic acid mono/diglycerides: PCA; PEG-36 castor oil; PEG-10 cocamine; PEG-2 laurate; PEG-2, tallowamine; PEG-5 tallowamine; PEG-15 tallowamine; PEG-20 tallowamine; Poloxamer 101; Poloxamer 108; Poloxamer 123; Poloxamer 124; Poloxamer 181; Poloxamer 182; Poloxamer 184; Polox amer 185; Poloxamer 188; Poloxamer 217; Poloxamer 231: Poloxamer 234; Poloxamer 235; Poloxamer 237; Poloxamer 282; Poloxamer 288; Poloxamer 331; Poloxamer 333; Polox amer 334; Poloxamer 335; Poloxamer 338; Poloxamer 401; Poloxamer 402: Poloxamer 403; Poloxamer 407; Poloxam ine 304; Poloxamine 701; Poloxamine 704; Poloxamine 901; Poloxamine 904; Poloxamine 908; Poloxamine 1107; Poloxamine 1307; Polyamide/epichlorohydrin polymer; Polyglyceryl-lo tetraoleate; Propylene glycol laurate; Propylene glycolmyristate; PVM/MA copolymer; polyether; Quaternium 18: Slearamidopropyl dimethyl-beta.-hydroxyethyl ammonium dihydrogen phosphate; Stearamidopropyl dimethyl-2-hydroxyethylammonium nitrate; Sulfated peanut oil; Tetra (2, diallyoxymethyl-1 butoxy titanium di(di-tridecyl) phosphite; Tetrahydroxypropyl ethylenediamine; Tetraisopropyl di(dioctylphosphito)titanate; Tetraoctyloxytitanium di(ditridecylphosphite); Titanium di(butyl, octyl pyrophosphate)di(dioctyl, hydrogen phosphite)oxyacetate; Titanium di (cumylphenylate)oxyacetate; Titanium di(dioctylpyro-phosphate) oxyacetate; Titanium dimethacrylate oxyacetate.

Marklear AFL-23 or Markstat AL-14, polyethers available from Whitco Industries, could be used as anti-static agents.

The antistatic coating may be applied on the back Surface of the Support by, for example, spreading a solution comprising an antistatic agent (i.e., with a metering rod) onto the back Surface of the Support and then drying the Support.

An example of one Support of the present invention is Georgia Pacific brand Microprint Laser Paper. However, any non-woven cellulosic or film Support may be used as the Support in the present invention.

B. Application of Layers

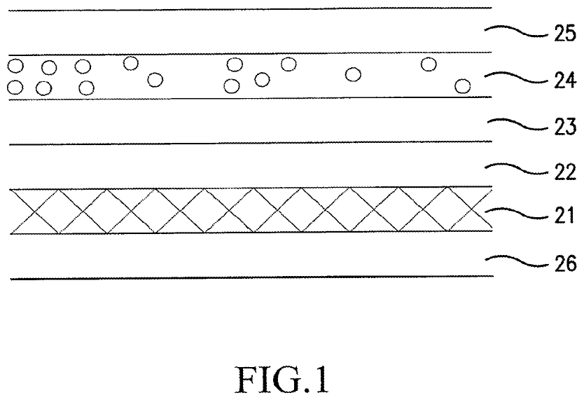

The various layers of the transfer material are formed by known coating techniques, such as by curtain coating, Meyer rod, roll, blade, air knife, cascade and gravure coating procedures. In addition, it is also possible to apply the melt transfer layer by extrusion coating or lamination. In referring to FIG. 1, there is generally illustrated a cross-sectional view of one embodiment of the transfer sheet of the present invention. The Support 21 comprises a top and bottom surface. On the top surface of the support is the optional barrier layer 22. On top of the barrier layer is the melt transfer layer 23. On top of the melt transfer layer is the opaque layer 24. On top of opaque layer is the image receiving layer 25. The image is placed over the image receiving layer 25 on the side opposite the support material. An optional anti-static 26 layer may be coated on the bottom surface of the support 21. The melt transfer layer may either be extrusion coated or laminated onto the optional barrier coated support. These are performed by methods conventional in the art.

C. Receptor Element

The receptor or receiving element receives the transferred image. A suitable receptor includes but is not limited to textiles including cotton fabric, and cotton blend fabric. The receptor element may also include glass, metal, wool, plastic, ceramic or any other suitable receptor. Preferably the receptor element is a tee shirt or the like.

The image, as defined in the present application may be applied in any desired manner. For example, the image may be formed by a color or monochrome laser printer, laser copier, bubblejet printer, inkjet printer, and the like. The image may also be applied using commercial printing methods such as sheet-fed offset, Screen and gravure printing methods or with crayons or markers.

To transfer the image, several alternatives exist. For instance, the transfer material may be first imaged. Then, the imaged image receiving layer, opaque layer(s) and melt transfer layer are peeled away from the support material and placed preferably image side up, melt transfer layer down, against a receptor element.

Alternatively, imaging step can wait until after the peeled image receiving layer, opaque layer(s) and melt transfer layer are placed upon the receptor. In this alternative, the image receiving layer, opaque layer(s) and melt transfer layer are preferably placed melt transfer layer down, where imaging is done by handwriting or drawing while using a marker or crayon, etc.

After the image receiving layer and melt transfer layer (or possibly the image receiving layer, one or more opaque layer and melt transfer layer) are placed on the receptor element, whether they are imaged or not, the next step is that a heat source, for instance a hand iron, a heat press or an oven is used to apply heat to the top imaged surface which in turn releases the image. If a hand iron or heat press is used that is not made of a tack-free material (such that the imaged material layer will stick thereto), a non-stick sheet should be placed between the heat source and the imaged material. However, even if the heat source, be it a hand iron or heat press, is made of a tack-free material, a non-stick sheet may still be placed between the heat Source and the imaged material.

Alternatively, heat may be applied to the back surface of the receptor element. In this alternative there is no need for a tack-free sheet regardless of the heat source used.

The temperature transfer range of the hand iron is generally in the range of 110 to 220° C. with about 190° C. being the preferred temperature. The heat press operates at a temperature transfer range of 100 to 220° C. with about 190° C. being the preferred temperature. Lastly, if a conventional oven is used, the temperature should be set within the range of 110 to 220° C. with about 190° C. being the preferred temperature.

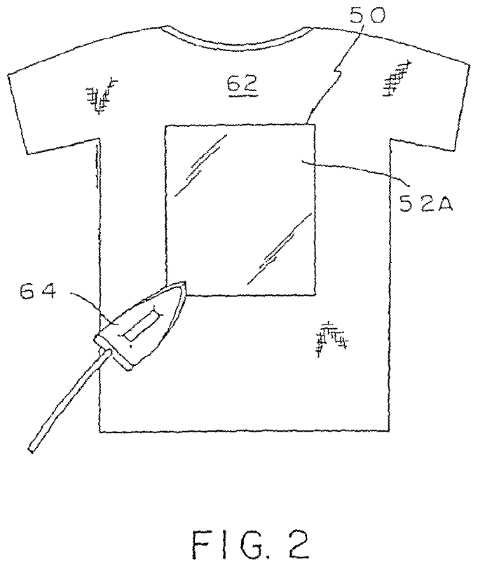

In the hand iron or heat press transfer, the heat source is preferably placed over the imaged side of peeled image receiving layer and melt transfer layer. However, as indicated above, the hand iron or heat press may be applied to the side of the receptor element opposite the peeled layer. With a hand iron, the iron is preferably moved in a circular motion. Pressure (i.e., typical pressure applied during ironing) should be applied as the heating device is moved over the Support (see FIG. 2). For a 8.5×11 (US Letter) inch web, heat is applied for about two minutes to five minutes (with about three minutes being preferred) using a hand iron and 10 seconds to 50 seconds using a heat press (with about twenty seconds being preferred) of heat and pressure, the transfer should be complete. The heating time requirement may be proportionally shorter or longer depending on the web size. The optional non-stick sheet is removed either prior to cooling or after cooling. The non-stick sheet is not required if the heating device is made of a non-stick material.

Referring to FIG. 2, the method of applying an image to a receptor element will be described. More specifically, FIG. 2 illustrates how the step of heat transfer from the transfer sheet 50 to a tee shirt or fabric 62 may be performed. A tee shirt 62 is laid flat, as illustrated, on an appropriate Support Surface, and the imaged surface of the peeled image receiving layer, opaque layer(s) and melt transfer layer is preferably positioned up and away from the tee shirt. A non-stick layer 52A is then placed on top of the peeled imaged material. An iron 64 set at optimum heat setting is run and pressed across the non-stick sheet. The image is transferred to the tee shirt and the non-stick sheet is removed and discarded or saved for reuse.

The non-stick sheet is any non-stick or tack-free sheet in the art including but not limited to a silicone sheet, a parchment paper sheet, a sheet coated with a barrier layer according to the present invention, or a Substrate or Support sheet.

In a preferred embodiment, the method of ironing as described in U.S. Pat. No. 6,539,652, which is herein incorporated by reference, can be used.

The following examples are provided for a further understanding of the invention; however, the invention is not to be construed as limited thereto.

### EXAMPLES

### Example 1

In one embodiment of the invention, the melt transfer layer is an ethylene acrylic acid co-polymer. An example of this embodiment is Melt Transfer Layer Formulation 1:

Melt Layer Formulation 1

| Components | Parts by weight |
|---|---|
| Ethylene Acrylic Acid Copolymer Dispersion | 100 parts |

The Melt Transfer Layer Formulation 1 is coated on a support or optionally barrier coated support in as supplied liquid dispersion form with a dry coat weight about 2 to 40 g/m², with a preferred dry coat weight would be 10-30 g/m².

### Example 2

This example relates to another melt transfer layer formulation, Melt Transfer Layer Formulation 2.

Melt Layer Formulation 2

| Components | Parts by weight |
|---|---|
| Ethylene Acrylic Acid Copolymer | 100 parts |

The Melt Transfer Layer Formulation 2 is extrusion coated on a support or optionally barrier coated support with a thickness of 1 to 2 mils., with a preferred thickness of 1 to 1.5 mils.

### Example 3

This example relates to an opaque layer formulation, Opaque Layer Formulation 1.

Opaque Layer Formulation 1

| | Parts by weight |
|---|---|
| Components | (dry) |
| Dispersants | 0.1 to 2 parts |
| TiO₂ or White Pigment | 26 to 50 parts |
| Polyurethane binder | 40 to 60 parts |
| Polyethylene Glycol- Plasticizer | 3 to 10 parts |
| Wax emulsion | 2 to 10 parts |
| Surfactants | 0.4 to 3 parts |
| Rheology modifier | 0.05 to 2 parts |

### Example 4

This example relates to an image receiving layer formulation, Image Receiving Layer Formulation 1.

Image Receiving Layer Formulation 1

| | Parts by weight |
|---|---|
| Components | (dry) |
| 28% Polyamide | 25 to 35 parts |
| Dispersant | 2.5 to 5 parts |
| Wax-treated pigment | 13 to 25 parts |
| Polyurethane binders | 15 to 30 parts |
| Cationic Polymer | 3 to 5 parts |
| Vinyl Acetate-Ethylene emulsion | 8 to 15 parts |
| Surfactants | 1 to 3 parts |
| Defoamer or anti-foaming agent | 0.9 to 2 parts |
| Water repellant | 11 to 25 parts |

Image Receiving Layer Formulation 1 is displayed in dry parts by weights. However, some of the above ingredients correspond to wet amounts added to create the formulation. To prepare, first stock solution is prepared in water. These are as follows:

28% Polyamide solution

| | Parts by weight | |
|---|---|---|
| Components | (wet) | |
| Water | 100 | parts |
| Dispersant/Surfactant | 4 | parts |
| Polyamide (Orgasol 3501) | 35 | parts |
| Defoamer or anti-foaming agent | 1 | part |
| Rheology modifier | 0.2 | parts |

### Example 5

A transfer sheet according to the present invention is prepared as follows:

A release coated support layer is first coated with the melt transfer layer (melt transfer layer formulation 2) comprising an ethylene acrylic acid copolymer is extruded onto the barrier layer. Second, an Opaque layer (formulation 1) is applied using meyer rod coating method on top of melt transfer layer. Third, an Image Receiving Layer (formulation 1) is coated with meyer rod coater on top of the opaque layer.

After thermal drying, an image is formed on the side of the image receiving layer opposite the support material by an aqueous inkjet printer.

The transfer of the image area from the image transfer sheet is completed by peeling the imaged image receiving layer, opaque layer and melt transfer layer from the support, and placing the peeled material, image side up, on a cotton shirt. Next a non-stick sheet is placed on top of the imaged peeled material and heat and pressure from a conventional iron set on cotton/linen setting is applied through the non-stick sheet for a time sufficient to transfer the image area to the shirt (e.g. 3 minutes). The non-stick sheet is removed. Lastly, the imaged receptor is washed and dried ten times at normal setting while using a mild laundry detergent with cold wash/cold rinse. The imaged receptor exhibited good color saturation and print quality following the wash cycles. Good adhesion to fabric was still observed following ten wash cycles.

### Example 6

Example 5 is repeated, except that the back surface of the support (opposite the barrier layer) is coated with the following antistatic layer:

Anti-static Layer Formulation 1

| | Parts by weight |
|---|---|
| Components | (wet) |
| Water | 90 parts |
| Quaternary Ammonium Salt | 10 parts |

The antistatic Solution is applied in a long line across the top edge of the Support material using a #4 metering rod. The coated Support is force air dried for approximately one minute. The antistatic solution of this Example has the following characteristics: the Solution viscosity as measured on a Brookfield DV-II+viscometer, LV1 spindle (a 60 RPM is 2.0 (cP) at 24.5° C.

Once the support and antistatic coating are dry, the uncoated side of the support coated with the melt transfer layer, opaque layer and image receiving layer.

### Example 7

Example 6 is repeated, except that following formulation is used as the antistatic layer:

Anti-static Layer Formulation 2

| | Parts by weight |
|---|---|
| Components | (wet) |
| Water | 95 parts |
| Polyether | 5 parts |

### Example 8

A transfer sheet according to the present invention is prepared as follows:

A support layer is first coated with a melt transfer layer (formulation 2) comprising an ethylene acrylic acid copolymer is extruded onto the melt transfer layer. Second, an Opaque Layer (formulation 1) is coated on top of melt transfer layer. Third, an Image Receiving Layer (formulation 1) is coated on top of opaque layer.

After thermal drying, an image is formed on the side of the image receiving layer opposite the Support material by an eco-solvent inkjet printer.

The transfer of the image area from the image transfer sheet is completed by peeling the imaged image receiving layer and melt transfer layer from the Support, and placing the peeled material, image side up, on a cotton shirt. Next a non-stick sheet is placed on top of the imaged peeled material and heat and pressure from a heat press at 275° F. temperature and 40-50 psi pressure setting is applied through the non-stick sheet for a time interval of 10 to 20 seconds. The non-stick sheet is removed. Lastly, the imaged receptor is washed and dried ten times at normal setting while using a mild laundry detergent with cold wash/cold rinse. The imaged receptor exhibited good color saturation and print quality following the wash cycles. Good adhesion to fabric was still observed following the ten wash cycles.

### Example 9

A transfer sheet according to Example 7 of the present invention is prepared as follows:

A support layer is first coated with Antistatic Layer Formulation 1 on the uncoated side. Next, a melt transfer layer is extruded on the opposite side of the antistatic layer with Melt Transfer Layer Formulation 2. Next, an opaque layer, such as, Opaque Layer Formulation 1 is applied over the Melt Transfer Layer. Next, an Image Receiving Layer (formulation 1) is applied over the opaque layer.

After thermal drying, an image is then formed on the image receiving layer using a laser printer. After forming the image, the Melt Transfer Layer, Opaque Layer, and the Image Receiving Layer are peeled from the support.

After peeling off the support, the image transfer sheet is placed, image side up, on a cotton shirt. Next a non-stick sheet is placed on top of the imaged material and heat and pressure from a conventional iron set on cotton setting is applied through the non-stick sheet for a time sufficient to transfer the image area to the shirt (e.g. 3 minutes). The non-stick sheet is removed. Lastly, the imaged receptor is washed and dried ten times at normal setting while using a mild laundry detergent with cold wash/cold rinse. The imaged receptor exhibited good color saturation and print quality following the wash cycles. Good adhesion to fabric was still observed following the ten wash cycles.

All cited patents, publications, copending applications, and provisional applications referred to in this application are herein incorporated by reference.

The invention being thus described, it will be obvious that the same may be varied in many ways. Such variations are not to be regarded as a departure from the spirit and scope of the present invention, and all Such modifications as would be obvious to one skilled in the art are intended to be included within the scope of the following claims.

What is claimed is:

1. An image transfer article, comprising:
a melt transfer layer having a top surface and a bottom surface, the bottom surface position-able against a receptor element during a transfer process;
an image receiving layer having an image receiving surface configured to receive indicia or an image, wherein the image receiving layer comprises at least one wax treated silica pigment and at least one polyurethane binder; and
at least one opaque layer disposed between the image receiving layer and the top surface of the melt transfer layer, the at least one opaque layer configured to provide an opaque background for at least a portion of the image.

2. The article of claim 1, wherein the opaque background comprises a substantially white opacity provided by a white pigment or a substantially colored opacity provided by a colored pigment.

3. The article of claim 2, wherein the white pigment comprises titanium oxide or the colored pigment comprises a pigmented resin.

4. The article of claim 1, wherein the opaque layer comprises of optionally coated more than one opaque layers, and wherein each opaque layer has a composition that is different from the other opaque layer.

5. The article of claim 1, wherein the polyurethane binder comprises a cationic polyurethane and/or a non-ionic polyurethane.

6. The article of claim 1, wherein the image receiving layer is capable of receiving printed images from electrostatic printers, laser printers, inkjet printing, eco-solvent printers, latex printers, and liquid toner printers.

7. An image transfer article comprising:
(i) a support;
(ii) a melt transfer layer on the support,
(iii) an opaque layer positioned between the melt transfer layer and an image receiving layer, the at least one opaque layer configured to provide an opaque background to received indicia or image;
(iv) the image receiving layer having an image receiving surface configured to receive indicia or an image, the image receiving layer comprising a one wax treated silica pigment and a polyurethane binder; and
(v) an anti-static coating on a surface of the support opposite the melt transfer layer.

8. The article of claim 7, wherein the opaque background includes a substantially white opacity provided by a white pigment or a substantially colored opacity provided by a colored pigment.

9. The article of claim 8, wherein the white pigment comprises titanium oxide or the colored pigment comprises a pigmented resin.

10. The article of claim 7 comprising at least two opaque layers, wherein each opaque layer has a composition that is different from the other opaque layers.

11. The article of claim 7, wherein the polyurethane binder in the imaging layer comprises a cationic polyurethane and/or a non-ionic polyurethane.

12. The article of claim 7, wherein the image receiving layer is capable of being imaged by an electrostatic printer, a laser printer, an inkjet printer, and a liquid toner printer.

13. A method of applying an image to a receptor, the method comprising:
printing an image and/or indicia on an image transfer article, the image transfer article comprising:
a melt transfer layer having a top surface and a bottom surface; at least one opaque layer disposed on the top surface of the melt transfer layer, the at least one opaque layer configured to provide an opaque background for at least a portion of the image; and
an image receiving layer disposed on the opaque layer, the image receiving layer having an image receiving surface configured to receive indicia or an image, wherein the image receiving layer comprises at least one wax treated silica pigment and at least one polyurethane binder; and
positioning the image transfer article on the receptor, with the bottom surface of the melt transfer contacting the receptor; and
applying heat and pressure to the image transfer article on the receptor.

14. The method of claim 13 wherein applying heat and pressure comprises ironing with a hand iron.

15. The method of claim 13 wherein printing comprises printing with an electrostatic printer, a laser printer, an inkjet printer, an eco-solvent printer, a latex printers, or a liquid toner printer.

16. The method of claim 15 wherein printing comprises printing with a laser printer.

17. The method of claim 13 further comprising, after positioning the image transfer article on the receptor, placing a nonstick sheet on the image transfer article.

18. The method of claim 17 wherein the image transfer article further comprises a substrate, wherein the bottom surface of the melt transfer layer is on the substrate, the method further comprising, before the step of positioning the image transfer article on the receptor, peeling the substrate off of the image transfer article.

19. The method of claim 18 wherein the image receiving layer further comprises a polyurethane binder.

20. The method of claim 13 wherein the opaque background comprises a substantially white opacity provided by a white pigment or a substantially colored opacity provided by a colored pigment.
